(19) United States
(12) Patent Application Publication
(10) Pub. No.: US 2026/0347608 A1
(43) Pub. Date: Nov. 5, 2026

(54) CURABLE THERMALLY CONDUCTIVE COMPOSITION

(71) Applicant: DOW SILICONES CORPORATION, Midland, MI (US)

(72) Inventors: Yan ZHENG, Shanghai (CN); Dorab Edul BHAGWAGAR, Auburn, MI (US); Qi CHEN, Shanghai (CN)

(21) Appl. No.: 19/478,130

(22) PCT Filed: Apr. 27, 2023
(86) PCT No.: PCT/CN2023/091030

§ 371 Date: Oct. 23, 2025

(51) Int. Cl. C08L 83/04; C08G 77/08; C08G 77/12; C08G 77/20; C08K 5/5419; C08K 7/18; C08K 9/06

(52) U.S. Cl. CPC C08L 83/04; C08G 77/08; C08G 77/12; C08G 77/20; C08K 5/5419; C08K 7/18; C08K 9/06; C08K 2201/001; C08K 2201/005; C08K 2201/014

(57) ABSTRACT

A curable thermally conductive composition contains: (A) from 1.0 to 4.0 weight-percent of a specified alkenyl-functional polyorganosiloxane; (B) a silyl-hydride functional polysiloxane crosslinker containing at least two silyl-hydride groups per molecule, present at a concentration to provide a molar ratio of silicon-bonded hydrogen atoms to alkenyl groups for the composition of 0.4 to 1.5; (C) from 92 to 96 weight-percent of thermally conductive fillers comprising: (c1) from 15 to 40 weight-percent of spherical magnesium oxide particles having a D50 of 70 to 130 micrometers, (c2) from 15 to 45 weight-percent of aluminum oxide particles having a D50 of 15 to 40 micrometers, (c3) from 20 to 32 weight-percent of spherical aluminum oxide particles having a D50 of 1 to 5 micrometers, and (c4) from 8 to 20 weight-percent of zinc oxide particles having a D50 of 0.1 to less than 1 micrometer; and (D) a filler treating agent.

### FIELD

The present invention relates to curable thermally conductive compositions that contain thermally conductive fillers including a novel combination of at least four different thermally conductive particles.

### INTRODUCTION

An industry drive to smaller and more powerful electronic devices has increased demands on thermally conductive compositions useful for dissipating heat generated in such devices. For instance, the telecommunications industry is going through a generational shift to 5G networks, which demand highly integrated electrical devices with smaller sizes and that brings a requirement for double the power requirements (1200 Watts from 600 Watts). The heat generated by the high power in the smaller devices would damage the device if not efficiently dissipated. Thermally conductive interface materials are often used in electronics to thermally couple heat generating components and heat dissipating components.

A challenge with thermally conductive interface materials is to provide a combination of both high thermal conductivity properties while being easily extrudable so as to allow precise application of the thermally conductive material on small components. In particular, it is desirably to provide a thermally conductive interface material that has an extrusion rate of at least 60 grams per minute as measured using the Extrusion Rate Test defined herein below and that cures to a material that has a thermal conductivity of at least 8.5 Watts per meter*Kelvin as measured using a hot disk according to ISO 22007-2.

Thermal conductivity may be increased by increasing the amount of thermally conductive fillers such as zinc oxide (ZnO), alumina (Al₂O₃), aluminum nitride (AlN), and magnesium oxide (MgO). However, increasing the filler loading has limitations on improving the thermal conductivity that may also depend on various parameters such as types, filling ratios, particle shapes, and particle sizes of each thermally conductive filler incorporated. For example, using only one or two type of these fillers has difficulties to achieve the above high thermal conductivity requirement. Even using a blend of three types of thermally conductive fillers, the extent that thermal conductivity can be improved also depends on a combination of specific concentrations and particle diameters for each filler. Moreover, increasing the amount of thermally conductive fillers typically reduces the extrusion rate for a composition which can even become a powdery paste. Therefore, meeting these two performance parameters is particularly challenging.

There remains a need to identify a thermally conductive composition that can simultaneously achieve the above described extrusion rate and thermal conductivity properties.

### SUMMARY

The present invention provides a thermally conductive interface material that has an extrusion rate of 60 grams per minute (g/min) or more as measured using the Extrusion Rate Test defined herein below and that cures to a material that has a thermal conductivity of at least 8.5 Watts per meter*Kelvin (W/m*K) using a hot disk according to ISO 22007-2. Surprisingly, it has been determined such a composition can be prepared from a curable polysiloxane composition (also as “curable thermally conductive composition”) that comprises a novel combination of specific amounts of at least four thermally conductive fillers different in types and/or particle size.

In a first aspect, the present invention is a curable thermally conductive composition comprising:
(A) from 1.0 to 4.0 weight-percent of an alkenyl-functional polyorganosiloxane having a viscosity in a range of 25 to 500 millipascal*seconds as determined by ASTM D445-21 using a glass capillary Cannon-Fenske type viscometer at 25 degrees Celsius, wherein the alkenyl-functional polyorganosiloxane has an average chemical structure (I):

R^{a}_{(3-c)}R′_{c}SiO—(R′R^{a}SiO)ₐ—(R^{a}₂SiO)_{b}—SiR′_{d}R^{a}_{(3-d)} (I)
where R^{a} is independently in each occurrence a monovalent hydrocarbon group free of aliphatic unsaturation, R′ is independently in each occurrence an alkenyl group, subscript a≥0, subscript b>0, subscript c is 0 or 1, subscript d is 0 or 1, (a+b) is 20 to 200, and (a+c+d)≥2;
(B) a silyl-hydride functional polysiloxane crosslinker that contains at least two silyl-hydride groups per molecule and that is present at a concentration to provide a molar ratio of silicon-bonded hydrogen atoms to alkenyl groups for the composition of 0.4 to 1.5;
(C) from 92 to 96 weight-percent of thermally conductive fillers comprising:
(c1) from 15 to 40 weight-percent of spherical magnesium oxide particles having a D50 in a range of 70 to 130 micrometers,
(c2) from 15 to 45 weight-percent of aluminum oxide particles having a D50 in a range of 15 to 40 micrometers,
(c3) from 20 to 32 weight-percent of spherical aluminum oxide particles having a D50 in a range of 1 to 5 micrometers, and
(c4) from 8 to 20 weight-percent of zinc oxide particles having a D50 in a range of 0.1 to less than 1 micrometer; and
(D) a filler treating agent selected from a trialkoxysilyl diorganopolysiloxane, an alkyl trialkoxysilane, or mixtures thereof;
where weight-percentages are relative to curable thermally conductive composition weight.

In a second aspect, the present invention is a process for using the curable thermally conductive composition of the first aspect, comprising:
(i) providing the curable thermally conductive composition,
(ii) applying the curable thermally conductive composition on an electronic component, and
(iii) curing the curable thermally conductive composition by heat.

In a third aspect, the present invention is an electronic article comprising the thermally conductive composition of the first aspect and an electronic component where the thermally conductive composition is applied on, wherein the curable thermally conductive composition is in a cured form.

### DETAILED DESCRIPTION

Test methods refer to the most recent test method as of the priority date of this document when a date is not indicated with the test method number. References to test methods contain both a reference to the testing society and the test method number. The following test method abbreviations and identifiers apply herein: ASTM refers to ASTM International methods and ISO refers to International Organization for Standards.

Products identified by their tradename refer to the compositions available under those tradenames on the priority date of this document. “And/or” means “and, or as an alternative”. All ranges include endpoints unless otherwise indicated. Unless otherwise stated, all weight-percent (wt %) values are relative to composition weight.

“Spherical” shaped particles refer to particles that have an aspect ratio of 1.0+/−0.2. The aspect ratio of a particle is determined using scanning electron microscope (SEM) imaging and by taking the average ratio of the longest dimension (major axis) and shortest dimension (minor axis) of at least ten particles.

“Roundish” refers to a shape in which the corners of the particles are small, and the entire particles are single grain with less crystal edges. The roundish particles have an aspect ratio other than 1.0+/−0.2, may be elliptical, or the like, but does not include a sphere.

“Polyhedron” refers to a shape surrounded by a plurality of planes such as a hexahedron, an octahedron, and a dodecahedron. Each plane does not necessarily have the same shape.

“Irregular” shaped particles refer to a shape that does not have a fixed shape such as “spherical”, “roundish”, or “polyhedron”. The irregular particles have an aspect ratio other than 1.0+/−0.2 and have sharp, uneven, different shape corners evident by SEM imaging.

Particle size of thermally conductive fillers (which is used interchangeable with “average particle size” and “D50”) refers to the volume-weighted median value of particle diameter distribution (D50) using a Mastersizer™ (trademark of Malvern Instruments Limited) 3000 laser diffraction particle size analyzer from Malvern Instruments.

Viscosity of a polysiloxane is determined according to ASTM D445-21 using a glass capillary Cannon-Fenske type viscometer at 25 degrees Celsius (°C) unless otherwise stated.

The curable thermally conductive composition of the present invention can undergo a crosslinking reaction (“curing”). In the present composition, the crosslinking reaction is a hydrosilylation reaction between alkenyl-functional polyorganosiloxane components and silyl-hydride (SiH) functional polysiloxane crosslinker.

The curable thermally conductive composition of the present invention comprises an alkenyl-functional polyorganosiloxane that has two or more alkenyl groups per molecule (component (A)). “Alkenyl” means a branched or unbranched, monovalent hydrocarbon group having one or more carbon-carbon double bonds. The alkenyl groups can be terminal, pendant, or a combination of both terminal and pendant. “Terminal” groups are on end siloxane groups of a molecule. “End” siloxane groups are attached to only one other siloxane group. “Pendant” groups are on interior siloxane group—siloxane groups bound to at least two other siloxane groups—of the molecule. “Siloxane group” is a group containing SiO that is bound to another Si through the oxygen of the SiO. Desirably, the alkenyl-functional polydiorganosiloxane has an average of one or more terminally alkenyl groups per molecule. The alkenyl-functional polyorganosiloxane has a viscosity in a range of 25 to 500 millipascal*seconds (mPa*s). The alkenyl-functional polyorganosiloxane may be a combination of two or more alkenyl-functional polyorganosiloxanes that may differ in one or more properties selected from molecular weight, structure, siloxane units and sequence. When the alkenyl-functional polyorganosiloxane is a combination of more than one alkenyl-functional polyorganosiloxane then the viscosity is the combined viscosity of alkenyl-functional polyorganosiloxanes. The viscosity of the alkenyl-functional polyorganosiloxane is 25 to 500 mPa*s, and can be 25 mPa*s or more, 30 mPa*s or more, 40 mPa*s or more, 50 mPa*s or more, 60 mPa*s or more, 70 mPa*s or more, 75 mPa*s or more, 78 mPa*s or more, even 80 mPa*s or more while at the same time is 500 mPa*s or less, and can be 400 mPa*s or less, 300 mPa*s or less, 200 mPa*s or less, 150 mPa*s or less, 100 mPa*s or less, 90 mPa*s or less, even 80 mPa*s or less, desirably 30 to 100 mPa*s, as determined by using a glass capillary Cannon-Fenske type viscometer at 25 degrees Celsius (°C) according to ASTM D445-21.

The alkenyl-functional polyorganosiloxane (A) useful in the present invention may have an average chemical structure (I):

R^{a}_{(3-c)}R′_{c}SiO—(R′R^{a}SiO)ₐ—(R^{a}₂SiO)_{b}—SiR′_{d}R^{a}_{(3-d)} (I)
where R^{a} is independently in each occurrence a monovalent hydrocarbon group free of aliphatic unsaturation. The monovalent hydrocarbon group is exemplified by an alkyl group of 1 to 6 carbon atoms or an aryl group of 6 to 10 carbon atoms, R′ is independently in each occurrence an alkenyl group, subscript a is zero or more (≥0), subscript b is greater than zero (>0), subscript c is 0 or 1, subscript d is 0 or 1, (a+c+d) is 2 or more (≥2), and (a+b) is 20 to 200.

Suitable alkyl groups for R^{a} may include, for example, methyl, ethyl, propyl (e.g., iso-propyl and/or n-propyl), butyl (e.g., isobutyl, n-butyl, tert-butyl, and/or sec-butyl), pentyl (e.g., isopentyl, neopentyl, and/or tert-pentyl), hexyl, as well as branched saturated hydrocarbon groups of 6 carbon atoms. Suitable aryl groups for R^{a} are exemplified by phenyl, tolyl, xylyl, naphthyl, benzyl, and dimethyl phenyl. Each R^{a} may be the same or different. Each R^{a} can be an alkyl group. Desirably, each R^{a} is independently methyl, ethyl, or propyl, and more desirably, each R^{a} is methyl.

The alkenyl group for R′ typically has from 2 to 8 carbon atoms, from 2 to 6 carbon atoms or from 2 to 4 carbon atoms. Suitable alkenyl groups may include vinyl, allyl, butenyl, and hexenyl. Particularly suitable alkenyl groups for R′ vinyl, allyl, butenyl, and hexenyl. R′ may be same or different. Desirably, each R′ is selected from vinyl or hexenyl. More desirably, each R′ is vinyl.

Desirably, subscript a is zero, subscript c is 1, subscript d is 1, and each R^{a} is methyl.

Subscript a is the average number of (R′R^{a}SiO) groups per molecule. Subscript b is the average number of (R^{a}₂SiO) groups per molecule. Desirably, a quantity (a+b) is 25 to 200, and can be 25 or more, 30 or more, 40 or more, 50 or more, 60 or more, 70 or more, 80 or more, 90 or more, 100 or more, 120 or more, 140 or more, 160 or more, even 180 or more while at the same time is typically 200 or less, and can be 180 or less, 160 or less, 140 or less, 120 or less, 100 or less, 80 or less, 60 or less, even 40 or less, desirably, 25 to 60. Desirably, a quantity (a+c+d) is 2 or more, even 3 or more while at the same time is typically 30 or less, and can be 20 or less, 10 or less, or even 3 or less.

Examples of suitable alkenyl-functional polyorganosiloxanes include i) vinyldimethylsiloxy-terminated polydimethylsiloxane, ii) dimethylvinylsiloxy-terminated poly(dimethylsiloxane/methylvinylsiloxane), iii) dimethylvinylsiloxy-terminated polymethylvinylsiloxane, iv) trimethylsiloxy-terminated poly(dimethylsiloxane/methylvinylsiloxane), v) trimethylsiloxy-terminated polymethylvinylsiloxane, vi) dimethylvinylsiloxy-terminated poly(dimethylsiloxane/methylvinylsiloxane), or mixtures thereof.

Desirably, the alkenyl-functional polyorganosiloxane comprises, or consists of, one or any combination of more than one vinyldimethylsiloxy-terminated polydimethylpolysiloxane (A1) having the average chemical structure (II):

Vi(CH₃)₂SiO—((CH₃)₂SiO)_{b}—Si(CH₃)₂Vi (II)
where Vi represents vinyl, and subscript b is the average number of ((CH₃)₂SiO) groups per molecule and has a value of 20 to 200, and can be 20 or more, 25 or more, 30 or more, 40 or more, 50 or more, 60 or more, 70 or more, 80 or more, 90 or more, 100 or more, 120 or more, 140 or more, 160 or more, even 180 or more while at the same time typically have a value of 200 or less, and can be 180 or less, 160 or less, 140 or less, 120 or less, 100 or less, 80 or less, 60 or less, even 40 or less. For example, the alkenyl-functional polyorganosiloxane can be a vinyldimethylsiloxy terminated polydimethylsiloxane having a viscosity of 78 mPa*s and containing 1.25 weight-percent (wt %) vinyl groups relative to molecular weight such as that available from Gelest under the name SMS-V21.

The concentration of component (A) the alkenyl-functional polyorganosiloxane may be 1.0 wt % to 4.0 wt %, and can be 1.0 wt % or more, 1.5 wt % or more, 1.8 wt % or more, 2.0 wt % or more, 2.4 wt % or more, 2.5 wt % or more, 2.6 wt % or more, 2.7 wt % or more, 2.8 wt % or more, 2.9 wt % or more, even 3.0 wt % or more while at the same time is generally 4 wt % or less, and can be 3.8 wt % or less, 3.5 wt % or less, 3.3 wt % or less, 3.0 wt % or less, 2.9 wt % or less, 2.8 wt % or less, 2.7 wt % or less, or even 2.6 wt % or less, desirably, 1.8 wt % to 2.8 wt %, based on the weight of the curable thermally conductive composition.

The curable thermally conductive composition of the present invention comprises a silyl-hydride (SiH) functional polysiloxane crosslinker (component (B), also referred to as “SiH crosslinker”). The SiH functional polysiloxane crosslinker contains at least two silyl-hydride groups (i.e., containing at least two silicon-bonded hydrogen atoms), or even 3 or more, per molecule. The SiH groups can be pendant, terminal or a combination of both pendant and terminal. The SiH functional polysiloxane crosslinker can have an average chemical structure (ITI):

R^{bb}₍₃₋ₕ)HₕSiO—(HR^{bb}SiO)ₑ—(R^{bb}₂SiO)_{f}—SiH_{h′}R^{bb}_{(3-h′)} (III)
where R^{hb} is independently in each occurrence selected from an alkyl group having from 1 to 6 carbon atoms and phenyl; subscripts h and h′ each are independently in each occurrence selected from a value in a range of zero to 3 provided that the combination of e, h, and h′ is at least 2; subscript e is zero to 30; and subscript f is 5 to 200.

The R^{bb} group can have one carbon or more, 2 carbons or more, 3 carbons or more, 4 carbons or more, even 5 carbons or more while at the same time 6 carbons or fewer, 5 carbons or fewer, 4 carbons or fewer, 3 carbons or fewer, even 2 carbons or fewer. Desirably, the R^{bb} group is independently in each occurrence selected from methyl and phenyl. H is a hydrogen atom.

Subscripts h and h′ refer to the average number of terminal hydrogen atoms on either end and each are independently in each occurrence selected from a value in a range of zero to 3 provided that the combination of e, h, and h′ is at least 2. Desirably, h and h′ are independently in each occurrence 0 or more, 1 or more, even 2 or more while at the same time 3 or less, 2 or less, even 1 or less. More desirably, h and h′ have the same value. Most desirably, h and h′ are both zero. Subscript e is the average number of (HR^{bb}SiO) groups per molecule. If h and h′ are both zero then e is in a range of 2 to 30. If h and h′ are both non-zero then subscript e can be zero to 30 provided the combination of e, h and h′ is 2 or more. Desirably, subscript e is 1 or more, and can be 2 or more and can be 3 or more, 4 or more, 5 or more, 6 or more, 7 or more, 8 or more, even 9 or more while at the same time typically is 30 or less, and can be 25 or less, 20 or less, 15 or less, 10 or less, 9 or less, 8 or less, 7 or less, 6 or less, 5 or less, 4 or less, 3 or less, even 2 or less. Subscript f is the average number of (R^{bb}₂SiO) groups per molecule. Generally, subscript f is 5 or more, 10 or more, 20 or more, 25 or more, 30 or more, 40 or more, 50 or more, and can be 75 or more, 100 or more, 125 or more, 150 or more, 175 or more, even 190 or more while at the same time is typically 200 or less, 175 or less, 150 or less, 125 or less, 100 or less, 75 or less, 50 or less, 40 or less, 30 or less, 25 or less, or even 20 or less.

Desirably, the SiH functional polysiloxane crosslinker has the structure of formula (III-a), (III-b), or combinations thereof:

H(CH₃)₂SiO—[(CH₃)₂)SiO)]ₓ—Si(CH₃)₂H (III-a)

(CH₃)₃SiO—[(CH₃)HSiO]_{y}[(CH₃)₂)SiO]_{z}—Si(CH₃)₃ (III-b)
where subscript x is 10 to 100, subscript y is 2 to 30, and subscript z is 3 to 100.

Desirably, component (B) is a combination of a SiH crosslinker of formula (III-a) and a SiH crosslinker of formula (III-b).

The SiH functional polysiloxane crosslinker may have a silicon-bonded hydrogen atom (“SiH”) content (i.e., SiH content) of 0.01 wt % to 1.0 wt %, and can be 0.01 wt % or more, 0.05% wt % or more, 0.1 wt % or more, 0.11 wt % or more, 0.15 wt % or more, 0.20 wt % or more, 0.25 wt % or more, 0.30 wt % or more, even 0.35 wt % or more while at the same time is generally 1.0 wt % or less, and can be 0.9 wt % or less, 0.8 wt % or less, 0.7 wt % or less, 0.6 wt % or less, 0.5 wt % or less, 0.4 wt % or less, even 0.36 wt % or less, desirably, 0.1 wt % to 0.8 wt %. SiH content refers to weight percentages of the silicon bonded hydrogen atoms relative to the molecular weight of the SiH functional polysiloxane crosslinker and can be determined using Fourier Transfer Infra-Red (FTIR) spectroscopy.

Suitable SiH functional polysiloxane crosslinkers may include, for example, trimethylsiloxy-terminated poly(dimethylsiloxane/methylhydrogensiloxane), trimethylsiloxy-terminated polymethylhydrogensiloxane, hydrogen-terminated polydimethylsiloxane, hydrogen-terminated poly(dimethylsiloxane/methylhydrogensiloxane), or mixtures thereof. The crosslinker may be a combination of two or more crosslinkers that may differ in one or more properties selected from molecular weight, structure, siloxane units and sequence, such as a mixture of trimethyl terminated dimethyl-co-hydrogen methyl polysiloxane and a hydride terminated polydimethylsiloxane. Specific examples of SiH crosslinkers include those having average chemical structure of Me₃SiO(Me₂SiO)₇(MeHSiO)₃SiMe₃, Me₃SiO(Me₂SiO)₁₀₈(MeHSiO)₁₀SiMe₃, Me₃SiO(Me₂SiO)₂₂(MeHSiO)₂SiMe₃, HMe₂SiO(Me₂SiO)₂₅(MeHSiO)₁SiMe₂H, or H(Me)₂SiO—[Me₂SiO)]₁₄—SiMe₂H, where Me represents methyl, or mixtures thereof. Suitable commercially available SiH crosslinkers include those available under the names HMS-071, HMS-501 and DMS-H11 all available from Gelest. Desirably, the SiH crosslinker can be one or a combination of both polymers selected from a group consisting of: (B-i) trimethyl terminated dimethyl-co-hydrogen methyl polysiloxane with a viscosity of 20-25 mPa*s and a SiH content of 0.10 wt %; and (B-ii) hydride terminated polydimethylsiloxane having a viscosity in a range of 7-10 mPa*s and a SiH content of 0.145 wt %.

The concentration of the SiH functional polysiloxane crosslinker is sufficient to provide a molar ratio of silicon-bonded hydrogen atoms from the crosslinker to alkenyl groups (desirably, vinyl groups) in the curable thermally conductive composition (also as “SiH/Vi ratio”) in a range of 0.4 to 1.5, and can be 0.4 or higher, 0.5 or higher, 0.6 or higher, 0.7 or higher, 0.8 or higher, even 0.9 or higher while at the same time is 1.5 or less, and can be 1.4 or less, 1.2 or less, 1.0 or less, 0.9 or less, 0.8 or less, 0.7 or less, or even 0.6 or less. Desirably, the SiH/Vi ratio is 0.6 to 1.2. The SiH/Vi ratio determines the extent of crosslinking that occurs when the curable thermally conductive composition cures. If the SiH/Vi ratio is too low, then the composition tends not to be sufficiently cured. If the SiH/Vi ratio is too high then the composition cures so much it may become brittle and suffer from surface cracking.

The curable thermally conductive composition of the present invention comprises thermally conductive fillers (component (C)). Component (C) comprises, and can consist of, a combination of at least four, or even five, different thermally conductive fillers, i.e., (c1), (c2), (c3), (c4), and optionally (c5), described below.

The first thermally conductive filler (c1) is spherical magnesium oxide particles having a D50 particle size of 70 μm to 130 μm, and can have a D50 of 70 μm or more, 75 μm or more, 80 μm or more, 85 μm or more, 90 μm or more, greater than 90 μm, 95 μm or more, 100 μm or more, even greater than 100 μm while at the same time have a D50 particle size of 130 μm or less, and can have a D50 of 125 μm or less, 120 μm or less, 110 μm or less, 100 μm or less, 95 μm or less, 90 μm or less, 85 μm or less, 80 μm or less, 75 μm or less, or even 70 μm or less. Desirably, the first thermally conductive filler (c1) has a D50 of 90 to 130 μm, more desirably, 90 μm to 120 μm, and even more desirably, 100 μm to 125 μm. The concentration of the spherical magnesium oxide particles (c1) is 15 wt % to 40 wt %, and can be 15 wt % or more, 15.1 wt % or more, 15.2 wt % or more, 15.3 wt % or more, 15.5 wt % or more, 16 wt % or more, 17 wt % or more, 18 wt % or more, 19 wt % or more, 20 wt % or more, 21 wt % or more, 22 wt % or more, even 25% or more while at the same time is 40 wt % or less, can be less than 40 wt %, 39 wt % or less, 38 wt % or less, 37 wt % or less, 36 wt % or less, 35 wt % or less, 30 wt % or less, 25 wt % or less, or even 22 wt % or less, desirably, 25 wt % to 38 wt %, based on the weight of the curable thermally conductive composition. Desirably, the first thermally conductive filler (c1) is 25 wt % to 38 wt % of spherical magnesium oxide particles having a D50 of 90 to 120 μm, based on the weight of the curable thermally conductive composition.

The second thermally conductive filler (c2) is aluminum oxide particles having a D50 particle size of 15 μm to 40 μm, and can have a D50 of 15 μm or more, 20 μm or more, 25 μm or more, 30 μm or more, even 35 μm or more while at the same time have a D50 particle size of 40 μm or less, and can have a D50 of 38 μm or less, 35 μm or less, 32 μm or less, or even 30 μm or less. Desirably, (c2) the aluminum oxide particles have a D50 particle size of 20 to 40 μm, and more desirably, 20 μm to 35 μm. The concentration of the second thermally conductive filler (c2) is 15 wt % to 45 wt %, and can be 15 wt % or more, 16 wt % or more, 17 wt % or more, 18 wt % or more, 19 wt % or more, 20 wt % or more, even 21 wt % or more while at the same time is 45 wt % or less, and can be 44 wt % or less, 43 wt % or less, 42 wt % or less, 40 wt % or less, 38 wt % or less, 36 wt % or less, 35 wt % or less, 32 wt % or less, 30 wt % or less, 25 wt % or less, or even 21 wt % or less, desirably, 15 wt % to 25 wt %, based on the weight of the curable thermally conductive composition. Desirably, the second thermally conductive filler (c2) comprises spherical, roundish, or polyhedron particles, or combinations of two or more aluminum oxide fillers different in shape or particle size as long as each having a D50 within 15 to 40 μm. Desirably, the second thermally conductive filler (c2) is spherical aluminum oxide particles.

The third thermally conductive filler (c3) is spherical aluminum oxide particles having a D50 particle size of 1 μm to 5 μm, and can have a D50 of 1 μm or more, 1.5 μm or more, even 2 μm or more while at the same time has a D50 particle size of 5 μm or less, and can have a D50 of 4.5 μm or less, 4 μm or less, 3.5 μm or less, 3 μm or less, 2.5 μm or less, or even 2 μm or less, desirably, 1.5 to 3.0 μm. The concentration of the third thermally conductive filler (c3) is 20 wt % to 32 wt %, and can be 20 wt % or more, 22 wt % or more, 24 wt % or more, 26 wt % or more, 28 wt % or more, even 30 wt % or more while at the same time is 32 wt % or less, and can be 31 wt % or less, 30 wt % or less, 29 wt % or less, 27 wt % or less, 25 wt % or less, 23 wt % or less, or even 21 wt % or less, desirably, 20 wt % to 30 wt %, based on the weight of the curable thermally conductive composition.

The fourth thermally conductive filler (c4) is zinc oxide particles has a D50 particle size of 0.1 μm to less than 1 μm, and can have a D50 of 0.1 μm or more, 0.2 μm or more, 0.3 μm or more, 0.5 μm or more, 0.7 μm or more, 0.8 μm or more, even 0.9 μm or more while at the same time has a D50 particle size less than 1 μm, and can have a D50 of 0.8 μm or less, 0.6 μm or less, 0.4 μm or less, or even 0.2 μm or less. The concentration of the fourth thermally conductive filler (c4) may be 8 wt % to 20 wt %, and can be 8 wt % or more, 10 wt % or more, 12 wt % or more, 13 wt % or more, even 13.5% or more while at the same time is generally 20 wt % or less, and can be 19 wt % or less, 18 wt % or less, 17 wt % or less, 15 wt % or less, 14 wt % or less, 13.6% or less, or even 13 wt % or less, desirably, 10 wt % to 18 wt %, based on the weight of the curable thermally conductive composition. Desirably, the fourth thermally conductive filler (c4) is irregular zinc oxide.

The fifth thermally conductive filler (c5), that is other than (c1) to (c4) described above, has a D50 particle size of 15 to 40 μm, and can have a D50 of 15 μm or more, 20 μm or more, 25 μm or more, 30 μm or more, even 35 μm or more while at the same time has a D50 particle size of 40 μm or less, and can have a D50 of 32 μm or less, 22 μm or less, or even 17 μm or less. The concentration of the fifth thermally conductive filler is zero to 30 wt %, and can be 5 wt % or more, 15 wt % or more, even 24 wt % or more while at the same time is 30 wt % or less, and can be 27 wt % or less, 20 wt % or less, 18 wt % or less, or even 10 wt % or less, based on the weight of the curable thermally conductive composition. The fifth thermally conductive filler may be selected from one or any combination of more than one of aluminum nitride, aluminum hydroxide, aluminum, and magnesium oxide. Desirably, the fifth thermally conductive filler is aluminum nitride particles. The fifth thermally conductive filler particles can have any shape such as spherical, irregular, roundish or polyhedron.

Desirably, the thermally conductive filler (C) comprises or consists of: (c1) from 25 to 38 wt % of spherical magnesium oxide particles having a D50 of 90 to 120 μm; (c2) from 15 to 25 wt % of spherical, roundish, or polyhedron aluminum oxide particles having a D50 of 20 to 40 μm; (c3) from 20 to 30 wt % of spherical aluminum oxide particles having a D50 of 1 to 5 μm; (c4) from 10 to 18 wt % of irregular zinc oxide particles having a D50 of 0.1 to 0.5 μm; and optionally (c5) from zero to 30 wt % of aluminum nitride particles having a D50 of 15 to 40 μm.

The total concentration of thermally conductive fillers (C) may be 92 wt % to 96 wt %, and can be 92 wt % or more, 93 wt % or more, 94 wt % or more, 94.4% or more, 94.5 wt % or more, 95 wt % or more, 95.4% or more, even 95.5 wt % or more while at the same time is 96 wt % or less, and can be 95.5 wt % or less, 95 wt % or less, even 94.5 wt % or less, based on the weight of the curable thermally conductive composition.

The curable thermally conductive composition of the present invention comprises a filler treating agent (component (D)). Component (D) may be selected from a trialkoxysilyl diorganopolysiloxane, an alkyl trialkoxysilane, or mixtures thereof. Component (D) is one or a combination of more than one filler treating agent. Component (D) the filler treating agent may comprise, or consists of, one or any combination of more than one trialkoxysilyl diorganopolysiloxane, which is a diorganopolysiloxane that contains a —Si(OR^{e})₃ group, where R^{e} is independently in each occurrence as described for R^{e} herein below in (IV). Desirably, the trialkoxysilyl diorganopolysiloxane is a mono-trialkoxysiloxy terminated diorganopolysiloxane. Suitable monotrialkoxysiloxy-terminated diorganopolysiloxanes include those having the average chemical structure (IV):

R^{c}₃Si[OR^{d}₂Si]_{g}—Y—Si(OR^{e})₃ (IV)
where R^{c}, R^{d}, and R^{e} are each independently in each occurrence hydrocarbon groups (hydrocarbyls) having 1 to 10 carbon atoms such as alkyl and aryl groups, for example, having 1 or more, 2 or more, 3 or more, 4 or more, 5 or more, 6 or more, 7 or more, even 8 or more carbon atoms while at the same time typically having 10 or fewer, 8 or fewer, 6 or fewer, 4 or fewer, even 2 or fewer carbon atoms; and subscript g typically has a value of 20 to 150, can be 20 or more, 25 or more, 30 or more, 40 or more, 50 or more, 60 or more, 70 or more, 80 or more, 90 or more, 100 or more, or even 110 or more, while at the same time typically has a value of 150 or less, and can be 130 or less, 125 or less, 120 or less, 110 or less, 100 or less, 90 or less, 80 or less, 70 or less, 60 or less, 50 or less, 40 or less, or even 30 or less; and Y is O or a (CH₂)ₙ linkage group, where subscript n has a value of 0 to 6, desirably Y is O. Desirably, subscript g has a value in a range of 25 to 110. Each R^{c}, R^{d}, and R^{e} can be the same or different. Suitable alkyl groups for R^{c}, R^{d}, and R^{e} are exemplified by methyl, ethyl, propyl (e.g., iso-propyl and/or n-propyl), butyl (e.g., isobutyl, n-butyl, tert-butyl, and/or sec-butyl), pentyl (e.g., isopentyl, neopentyl, and/or tert-pentyl), hexyl, as well as branched saturated hydrocarbon groups of 6 carbon atoms. R^{c}, R^{d}, and R^{e} each can be independently an alkyl group such as methyl, ethyl, and propyl. Desirably, each R^{c}, R^{d}, and R^{e} is methyl. Suitable aryl groups for R^{c}, R^{d}, and R^{e} may include phenyl and dimethyl phenyl. A particularly desirable monotrialkoxysiloxy-terminated diorganopolysiloxane is a monotrimethoxysiloxy and trimethylsiloxy terminated polydimethylsiloxane such as those having the average chemical formula (CH₃)₃SiO[(CH₃)₂SiO]₃₀Si(OCH₃)₃. Suitable mono-trialkoxysiloxy terminated dimethylpolysiloxanes can be synthesized according to the teachings in US2006/0100336.

Component (D) the filler treating agent may comprise or be free of one or a combination of more than one alkyl trialkoxysilane. Suitable alkyl trialkoxysilanes include those having the chemical formula (V):

R^{f}Si(OR^{g})₃ (V)
where R^{f} is independently in each occurrence an alkyl group having 6 to 20 carbon atoms, and can be 6 or more, 7 or more, 8 or more, 9 or more, or even 10 or more carbon atoms, while at the same time having 20 or less, and can be 18 or less, 16 or less, 14 or less, 12 or less, or even 10 or less carbon atoms; and R^{g} is independently in each occurrence an alkyl having 1 to 6 carbon atoms, and can be 1 or more, 2 or more, 3 or more, 4 or more, even 5 or more carbon atoms while at the same time generally having 6 or less, 5 or less, 4 or less, 3 or less, or even 2 or less carbon atoms. Desirably, R^{f} is independently in each occurrence an alkyl group having 6 to 12 carbon atoms. R^{g} is desirably methyl so as to form methoxyl groups attached to the silicon atom. A particularly desirable alkyl trialkoxysilane is n-decyltrimethoxysilane, n-octyltrimethoxysilane, or a mixture thereof. Suitable alkyl trialkoxysilanes include n-decyltrimethoxysilane available from The Dow Chemical Company as DOWSIL™ Z-6210 Silane or under the name SID2670.0 from Gelest (DOWSIL is a trademark of The Dow Chemical Company).

Component (D) the filler treating agent useful in the present invention may be present at a total concentration of 0.5 wt % to 2.5 wt %, and can be 0.5 wt % or more, 0.6 wt % or more, 0.7 wt % or more, 0.8 wt % or more, 0.9 wt % or more, 1.0 wt % or more, 1.2 or more, 1.3 wt % or more, 1.4 wt % or more, 1.5 wt % or more, 1.6% or more, even 1.7% or more while at the same time is typically 2.5 wt % or less, and can be 2.4% or less, 2.3 wt % or less, 2.2 wt % or less, 2.1 wt % or less, 2.0 wt % or less, or even 1.9 wt % or less, based on the weight of the curable thermally conductive composition. Desirably, the monotrialkoxysiloxy-terminated diorganopolysiloxane is present at a concentration of 0.5 to 2.5 wt %, and can be 0.5 wt % or more, 0.6 wt % or more, 0.7 wt % or more, 0.8 wt % or more, 0.9 wt % or more, 1.0 wt % or more, 1.1 wt % or more, 1.2 wt % or more, 1.5 wt % or more even 1.6 wt % or more while at the same time is typically present at a concentration of 2.5 wt % or less, and can be 2.4 wt % or less, 2.2 wt % or less, 2.0 wt % or less, 1.8 wt % or less, even 1.7 wt % or less, based on the weight of the curable thermally conductive composition. At the same time, or alternatively, the alkyltrialkoxysilane may be present at a concentration of zero to 0.4 wt %, and can be zero or more, 0.01 wt % or more, 0.05 wt % or more, 0.1 wt % or more, 0.14 wt % or more, even 0.15 wt % or more while at the same time is typically present at a concentration of 0.5 wt % or less, and can be 0.4 wt % or less, 0.3 wt % or less, or even 0.2 wt % or less, based on the weight of the curable thermally conductive composition.

The curable thermally conductive composition of the present invention may comprise or be free of one or more platinum (Pt)-based hydrosilylation reaction catalyst (component (E)). Such hydrosilylation reaction catalyst may include compounds and complexes such as platinum (0)-1,3-divinyl-1,1,3,3-tetramethyldisiloxane (Karstedt's catalyst), H₂PtCl₆, di-μ.-carbonyl di-.π.-cyclopentadienyldinickel, platinum-carbonyl complexes, platinum-divinyltetramethyldisiloxane complexes, platinum cyclovinylmethylsiloxane complexes, platinum acetylacetonate (acac), platinum black, platinum compounds such as chloroplatinic acid, chloroplatinic acid hexahydrate, a reaction product of chloroplatinic acid and a monohydric alcohol, platinum bis(ethylacetoacetate), platinum bis(acetylacetonate), platinum dichloride, and complexes of the platinum compounds with olefins or low molecular weight organopolysiloxanes or platinum compounds microencapsulated in a matrix or core-shell type structure. The hydrosilylation reaction catalyst can be part of a solution that includes complexes of platinum with low molecular weight organopolysiloxanes that include 1,3-diethenyl-1,1,3,3-tetramethyldisiloxane complexes with platinum. These complexes may be microencapsulated in a resin matrix (typically, in a phenyl resin) or non-encapsulated. The resin matrix for microencapsulating the complexes can be a phenyl resin, an acrylate polymer, a polycarbonate, or other resin matrix which has a melting point less than 150 °C to release Pt during heat curing. Exemplary hydrosilylation reaction catalysts are described in U.S. Pat. Nos. 3,159,601 and 3,220,972, and encapsulated platinum catalysts described in WO2014017671A1. The catalyst can be 1,3-diethenyl-1,1,3,3-tetramethyldisiloxane complex with platinum. Platinum-based hydrosilylation reaction catalysts are commercially available, for example, SYL-OFF™ 4000 Catalyst, SYL-OFF 4500 Catalyst, and SYL-OFF 2700 Catalyst are available from The Dow Chemical Company (SYL-OFF is a trademark of The Dow Chemical Company). In some embodiments, two different catalysts (e.g., E1 and E2) that activate at different temperatures can be added. The two different catalysts may be (E1) 1,3-diethenyl-1,1,3,3-tetramethyldisiloxane complex with platinum, and (E2) an encapsulated platinum catalyst, such as 1,3-diethenyl-1,1,3,3-tetramethyldisiloxane complex with platinum which is encapsulated in dimethyl siloxane with phenyl silsesquioxane.

The amount of component (E) the platinum-based hydrosilylation reaction catalyst is sufficient to provide 0.5 part per million (ppm) to 300 ppm, and can be 0.5 ppm or more, 5 ppm or more, 10 ppm or more, 20 ppm or more, even 30 ppm or more while at the same time is generally 300 ppm or less, and can be 200 ppm or less, 130 ppm or less, 100 ppm or less, or even 50 ppm or less, of the platinum, by weight based on the weight of the curable thermally conductive composition. Alternatively, the amount of the platinum-based hydrosilylation reaction catalyst may be 0.01 wt % to 0.6 wt %, and can be 0.01 wt % or more, 0.03 wt % or more, 0.04 wt % or more, 0.05 wt % or more, even 0.06 wt % or more while at the same time is typically 0.6 wt % or less, and can be 0.5 wt % or less, 0.4 wt % or less, 0.3 wt % or less, 0.2 wt % or less, 0.1 wt % or less, 0.09 wt % or less, 0.08 wt % or less, 0.07 wt % or less, or even 0.06 wt % or less, based on the weight of the curable thermally conductive composition.

The curable thermally conductive composition of the present invention may comprise or be free of one or a combination of more than one hydrosilylation reaction inhibitor (Component (F), also as “inhibitor”). Inhibitors can serve to stabilize the curable thermally conductive composition from premature curing and provide storage stability to the composition. Examples of suitable inhibitors include any one or any combination of more than one of acetylene-type compounds such as 2-methyl-3-butyn-2-ol; 3-methyl-1-butyn-3-ol; 3,5-dimethyl-1-hexyn-3-ol; 2-phenyl-3-butyn-2-ol; 3-phenyl-1-butyn-3-ol; 1-ethynyl-1-cyclohexanol; 1,1-dimethyl-2-propynyl)oxy)trimethylsilane; and methyl(tris(1,1-dimethyl-2-propynyloxy))silane; ene-yne compounds such as 3-methyl-3-penten-1-yne and 3,5-dimethyl-3-hexen-1-yne; triazols such as benzotriazole; hydrazine-based compounds; phosphines-based compounds; mercaptan-based compounds; cycloalkenylsiloxanes including methylvinylcyclosiloxanes such as 1,3,5,7-tetramethyl-1,3,5,7-tetravinyl cyclotetrasiloxane and 1,3,5,7-tetramethyl-1,3,5,7-tetrahexenyl cyclotetrasiloxane.

The concentration of component (F) the inhibitor may be zero to 0.5 wt %, and can be 0.001 wt % or more, 0.002 wt % or more, even 0.003 wt % or more while at the same time is typically 0.5 wt % or less, and can be 0.3 wt % or less, 0.1 wt % or less, 0.05 wt % or less, 0.01 wt % or less, 0.005 wt % or less, 0.004 wt % or less, even 0.003 wt % or less, based on the weight of the curable thermally conductive composition.

The curable thermally conductive composition of the present invention may comprise or be free of other optional components including any one or any combination of more than one of the following components: heat stabilizers and/or pigments (such as copper phthalocyanine powder), thixotropic agents, fumed silica (desirably, surface treated), and spacer additives (such as glass beads). The total concentration for these additional components can be in a range of from zero to 0.6 wt %, and can be zero or more, 0.1 wt % or more, 0.2 wt % or more, 0.3 wt % or more, 0.4 wt % or more, even 0.5 wt % or more while at the same time is typically 0.6 wt % or less, and can be 0.5 wt % or less, 0.4 wt % or less, 0.3 wt % or less, 0.2 wt % or less, 0.1 wt % or less, or even 0.05 wt % or less, based on the weight of the curable thermally conductive composition.

The curable thermally conductive composition of the present invention achieves an extrusion rate (ER) of 60 grams per minute (g/min) or more. Determine extrusion rates herein at a pressure of 0.62 MegaPascals (MPa) and 25 °C with a standard 30 cubic centimeters EFD syringe package (further details provided below under Extrusion Rate Test). The thermally conducive composition can have an extrusion rate of 60 g/min or more, 70 g/min or more, or even 80 g/min or more. ER is a useful characteristic as a measure of extrudability, viscosity, dispensability, which, for example, makes the curable thermally conductive composition easily dispensable for applying onto another material such as electronic components or heat sinks. At the same time, the curable thermally conductive composition of the present invention, upon curing, provides a thermal conductivity (TC) of at least 8.5 W/m*K, 8.7 W/m*K or more, or even 9.0 W/m*K or more, as measured using a hot disk according to ISO 22007-2 with cured samples (further details provided below under Thermal Conductivity Test). Having such a high TC (affording an efficient thermal dissipation) and by being easily dispensable makes the curable thermally conductive composition particularly useful as a thermally conductive interface material to efficiently transfer heat between two components. Thermally conductive interface materials are typically used to thermally couple heat generating components and heat dissipating components, especially in electronics.

The curable thermally conductive composition of the present invention may comprise or be free of one or a combination of more than one solvent. The concentration of solvent can be less than 0.01 wt %, less than 0.005 wt %, or even zero, based on the weight of the curable thermally conductive composition. Desirably, the curable thermally conductive composition is substantially free of a solvent, i.e., contains no solvent or may contain trace amounts of residual solvents from delivery of starting materials in the composition. The concentration of the solvent can be measured by gas chromatography (GC). If the amount of solvents is too high, voids tend to be generated during curing the curable thermally conductive composition, which gives poor surface appearance or even results in a decreased thermal conductivity. The solvent can be an organic solvent such as an aliphatic or aromatic hydrocarbon, which is saturated or unsaturated, such as benzene, toluene, xylene, hexane, heptane, octane, iso-paraffin, hydrocarbon compounds of 8 to 18 carbon atoms and at least one aliphatic unsaturation per molecule such as tetradecene; a ketone such as acetone, methyl ethyl ketone, or methyl isobutyl ketone; an ester acetate such as ethyl acetate or isobutyl acetate; an ether such as a glycol ether such as propylene glycol methyl ether, dipropylene glycol methyl ether, and propylene glycol n-butyl ether, diisopropyl ether or 1,4-dioxane; a cyclic or linear siloxane having an average degree of polymerization from 3 to 10 such as hexamethylcyclotrisiloxane, octamethylcyclotetrasiloxane, and/or decamethylcyclopentasiloxane; or mixtures thereof. The curable thermally conductive composition does not require the use of any solvents such as those described above while still achieving the desired ER (i.e., good processability) and TC properties above.

The present invention also relates to a method of preparing the curable thermally conductive composition, the method comprising: admixing the alkenyl-functional polyorganosiloxane, the SiH crosslinker, the thermally conductive fillers, the filler treating agent, and optionally, the hydroxylation reaction catalyst and the inhibitor and other optional components described above.

The present invention also includes a process for using the curable thermally conductive composition described above, the process comprising: step (i) providing the curable thermally conductive composition; step (ii) applying the curable thermally conductive composition on the electronic component for an electronic device; and step (iii) curing the curable composition by heat; thereby forming a thermally conductive silicone material (i.e., a cured material). Desirably, the applying of the curable thermally conductive composition involves dispensing or extruding the curable thermally conductive composition. Due to the above described properties of the curable thermally conductive composition such as excellent dispensability and conformability as indicated by the low ER above, the process allows for automated dispensing and assembly (i.e., increased productivity) with minimal stress applied to fill in intricate geometries and diverse gaps, therefore avoiding potential damages to the electronic components. In step (iii) of the process, the thermally conductive composition can be cured at room temperature or by heat, for example, at temperatures greater than 25 °C, and can be greater than 40 °C, or greater than 80 °C. The duration time for curing may vary depending on the temperatures, typically 0.5 to 24 hours. The curable thermally conductive composition can be cured at room temperature, or by heat generated by the electronic component. Desirably, when the electronic device is in operation, the heat generated from the electronic component cures the curable thermally conductive composition typically within several hours, thereby forming the cured material.

Due to the low concentration or absence of the solvent in the curable thermally conductive composition, the process does not involve (that is, is free of) an extra procedure for removal of the solvent, e.g., stripping off or evaporating the solvent. While still affording the resulting composition with desired ER and TC properties as described above, the curable thermally conductive composition enables the process for using the composition without the aid of a solvent and also makes it applicable to dispense (e.g., by extrusion) the composition directly onto components of articles without requiring addition of solvents to the composition before use.

Examples of the electronic components which generate heat during the electronic device is operated include central processing units (CPU), graphics processing units (GPU), memory chips, driver chips and optical modules. The thermally conductive composition can be applied on one or two electronic components which generate heat. The thermally conductive composition can be between and in contact with one electronic component and a heat dissipating component such as a heat sink, or between and in contract with two electronic components of the electronic device, where at least one electronic component generates heat when the electronic device is in operation. Examples of the heat dissipating components include a heat sink, cooling plate/pad, cooling tube, and metal cover. The present invention further relates to an electronic article. The electronic article can be formed by the above process or comprise the curable thermally conductive composition in a cured formed and the electronic component where the thermally conductive composition is applied on. The electronic article may also comprise another component such as another electronic component same as or different from the electronic component where the thermally conductive composition is applied on or the heat dissipating component described above, such that the thermally conductive composition can be between and in contact with one electronic component and the heat dissipating component, or between and in contract with the two electronic components. The electronic article of the present invention is useful as an electronic device. Examples of the electronic devices include optical modules, smartphones, digital cameras, computers, pad devices, servers and base stations for communication, power inverters, DC (direct current)-to-DC converters, advanced driver assistance systems (ADAS), and battery packs in electric vehicles (EV).

### EXAMPLES

Some embodiments of the invention will now be described in the following Examples, wherein all percentages (%) are by weight relative to the weight of a composition and all particle sizes of fillers are D50 particle sizes, unless otherwise specified. Table 1 lists the materials for use in the thermally conductive composition of the samples described herein below. Note: “Vi” represents vinyl, “Me” represents methyl, and “TC filler” refers to thermally conductive filler.

TABLE 1

| Component | Description | Source |
|---|---|---|
| Vi Polymer | Vinyl dimethyl terminated polydimethylsiloxane | Synthesized by ring-opening |
| A-1 | (PDMS) with a viscosity of 80 mPa*s at 25 °C | polymerization of cyclosiloxanes with |
| | and 1.3 wt % vinyl relative to molecular weight, | vinyl end-blockers for termination as |
| | having an average chemical structure: | described in U.S. Pat. No. 5,883,215. |
| | ViMe₂SiO—[Me₂SiO]₅₈—SiMe₂Vi | |
| SiH Crosslinker | Hydride terminated PDMS with a viscosity of 14 | Available as DMS-H11 from Gelest. |
| B-1 | mPa*s at 25 °C and 0.145 wt % of H from SiH | |
| SiH Crosslinker | Trimethyl terminated dimethyl-co-hydrogen | Available as HMS-031 from Gelest. |
| B-2 | methyl polysiloxane with a viscosity of 22 | |
| | mPa*s at 25 °C and 0.10 wt % of H from SiH | |
| Treating Agent | n-Decyltrimethoxysilane | Available as SID2670.0 from Gelest. |
| D-1 | | |
| Treating Agent | Monotrimethoxysiloxy and trimethylsiloxy | Synthesized according to the teachings |
| D-2 | terminated PDMS having an average chemical | in US2006/0100336 (such as paragraphs |
| | structure: Me₃SiO[Me₂SiO]₃₀Si(OMe₃)₃ | 101-103) |
| TC Filler C1-1 | Spherical magnesium oxide (“MgO”) particles | Available from Denka of Japan |
| | with a D50 of 120 μm | |
| TC Filler C1-2 | Spherical MgO particles with a D50 of 90 μm | Available from Denka of Japan |
| TC Filler C1-3 | Spherical MgO particles with a D50 of 50 μm | Available from Denka of Japan |
| TC Filler C2-1 | Polyhedron aluminum oxide (“Al₂O₃”) particles | Available from DIC Corporation of |
| | with a D50 of 30 μm | Japan |
| TC Filler C2-2 | Roundish Al₂O₃ particles with a D50 of 35 μm | Available from Zhengzhou Research |
| | | Institute Co. Ltd. of Chinalco of China |
| TC Filler C2-3 | Spherical Al₂O₃ particles with a D50 of 40 μm | Available from Denka of Japan |
| TC Filler C2-4 | Spherical Al₂O₃ particles with a D50 of 70 μm | Available from Denka of Japan |
| TC Filler C2-5 | Spherical Al₂O₃ particles with a D50 of 10 μm | Available from Nippon steel Chemical |
| | | & Material Co., Ltd. of Japan |
| TC Filler C2-6 | Irregular aluminum nitride (“AlN”) particles with | Available from Combustion Synthesis |
| | a D50 of 70 μm | Co., Ltd. of Japan |
| TC Filler C3-1 | Spherical Al₂O₃ particles with a D50 of 2 μm | Available from Micron of Japan |
| TC Filler C3-2 | Irregular Al₂O₃ particles with a D50 of 2 μm | Available from Sumitomo Chemical of |
| | | Japan |
| TC Filler C4-1 | Irregular zinc oxide (“ZnO”) particles with D50 | Available from Zochem, Inc. |
| | of 0.12 μm | |
| TC Filler C4-2 | Polyhedron Al₂O₃ particles with a D50 of 0.5 μm | Available from Denka of Japan |
| Catalyst | Karstedt's Catalyst composition | Available as SYL-OFF ™ 4000 catalyst |
| E-1 | | from The Dow Chemical Company. |
| Inhibitor | Methyl(tris(1,1-dimethyl-2-propynyloxy))silane | Available as ACM83817714 from Alfa |
| F-1 | | Chemistry. |
| Pigment G-1 | Copper phthalocyanine dispersed in a | Available as Stan-Tone ™ 40SP03 |
| | polydimethylsiloxane | from PolyOne |

*Viscosities of polysiloxanes were measured by ASTM D445-21 at 25 °C.

### Inventive Example (IE) 1-6 and Comparative Example (CE) 1-6 Samples

Formulations for the samples are in Tables 2 and 3, with the amount of each component reported in grams (g). Samples were prepared by using a SpeedMixer™ DAC 400 FVZ mixer from FlackTek Inc. (South Carolina, USA) to mix the components together. To a cup of the SpeedMixer add the Vi Polymer (A-1), SiH Crosslinkers (B-1) and (B-2), Treating Agents (D-1) and (D-2), and TC fillers C3 and C4 if present. Mix at 1000 revolutions per minute (RPM) for 20 seconds, then 1500 RPM for 20 seconds. Add TC fillers C2 and mix at 1000 RPM for 20 seconds, then 1500 RPM for 20 seconds. Add TC filler (C1) and mix in the same way. The resulting composition in the cup was scraped to ensure homogenous mixing and then Catalyst E-1, Inhibitor F-1, and Pigment G-1 were added and mixed in like manner to obtain the curable thermally conductive composition samples. The obtained thermally conductive composition samples were evaluated for extrusion rate and thermal conductivity, and appearance according to the following test methods:

### Extrusion Rate Test

Extrusion rate (“ER”) for a sample was determined using Nordson EFD dispensing equipment. Package sample material into a 30 cubic centimeter syringe with a 2.54 millimeter (mm) opening (EFD syringe form Nordson Company). Dispense sample at 25 °C through the opening by applying a pressure of 0.62 MPa to the syringe. The mass of the sample in grams (g) extruded after one minute corresponds to the extrusion rate in grams per minute (g/min). The objective of the present invention is to achieve an extrusion rate of at least 60 g/min. Notably, some samples were powdery pastes that could not be extruded so they are reported as having an ER of 0 (and thermal conductivity was not measured, thus reporting as “NA”).

### Thermal Conductivity Test

Thermal conductivity (“TC”) was determined using a hot disk according to ISO 22007-2. The thermal conductivity of cured samples was measured by Hot Disk TPS 2500 S instrument with a 3.189 mm Kapton sensor (model 5465). The cured samples were prepared by curing the curable thermally conductive composition samples prepared above at 100 °C for 60 min with dimension of 25 mm*25 mm*8 mm. The objective of the present invention is to achieve a thermal conductivity of at least 8.5 Watts per meter*Kelvin (W/m*K).

Each sample was characterized for extrusion rate using the Extrusion Rate Test and thermal conductivity using the Thermal Conductivity Test described herein, above.

Table 2 contains characterization results for IEs 1-6 samples. As shown in Table 2, all IEs 1-6 samples comprising the novel combination of specific amounts of different TC fillers (c1) though (c4) having specific particle sizes achieved both requirements of an ER of at least 60 g/min (or even 70 g/min or more) and a TC of at least 8.5 W/m*K (or even 9.0 W/m*K or more). IE1 sample demonstrated even higher TC and ER than IE6 sample.

TABLE 2

| Component | IE1 | IE2 | IE3 | IE4 | IE5 | IE6 |
|---|---|---|---|---|---|---|
| Vinyl Polymer A-1 | 1.893 | 1.848 | 1.836 | 1.893 | 1.893 | 1.893 |
| SiH Crosslinker B-1 | 0.490 | 0.476 | 0.476 | 0.490 | 0.490 | 0.490 |
| SiH Crosslinker B-2 | 0.150 | 0.145 | 0.145 | 0.150 | 0.150 | 0.150 |
| Treating Agent D-1 | 0.150 | 0.145 | 0.146 | 0.150 | 0.150 | 0.150 |
| Treating Agent D-2 | 1.700 | 1.650 | 1.650 | 1.700 | 1.700 | 1.700 |
| TC Filler C1-1 | 36.00 | 22.04 | 15.25 | 36.00 | 36.00 | |
| TC Filler C1-2 | | | | | | 36.000 |
| TC Filler C2-1 | | | | 21.000 | | |
| TC Filler C2-2 | 21.00 | 36.02 | 42.82 | | | 21.00 |
| TC Filler C2-3 | | | | | 21.000 | |
| TC Filler C3-1 | 24.90 | 24.56 | 24.56 | 24.90 | 24.90 | 24.90 |
| TC Filler C4-1 | 13.60 | 13.00 | 13.00 | 13.60 | 13.60 | 13.60 |
| Catalyst E-1 | 0.060 | 0.060 | 0.060 | 0.060 | 0.060 | 0.060 |
| Inhibitor F-1 | 0.008 | 0.008 | 0.008 | 0.008 | 0.008 | 0.008 |
| Pigment G-1 | 0.050 | 0.048 | 0.049 | 0.050 | 0.050 | 0.050 |
| Characterization | | | | | | |
| SiH/Vi ratio | 0.894 | 0.894 | 0.894 | 0.894 | 0.894 | 0.894 |
| Wt % filler | 95.5 | 95.6 | 95.6 | 95.5 | 95.5 | 95.5 |
| Vol % filler | 83.8 | 84.1 | 84.0 | 83.8 | 83.8 | 83.8 |
| Wt % s-MgO (70-130 μm) | 36.0 | 22.0 | 15.3 | 36.0 | 36.0 | 36.0 |
| Wt % Al₂O₃ (15-40 μm) | 21.0 | 36.0 | 42.8 | 21.0 | 21.0 | 21.0 |
| ER (g/min) | 76 | 87 | 82 | 83 | 86 | 60 |
| TC (W/m*K) | 9.186 | 8.727 | 8.502 | 8.926 | 9.175 | 8.758 |

Note:
In Table 2 and Table 3 below:
“Wt % filler” refers to wt % of total thermally conductive fillers relative to the total weight of all components in the sample.
“Vol % filler” refers to volume concentration of total thermally conductive fillers relative to the total volume of all components in the sample.
“SiH/Vi ratio” refers to molar ratio of SiH functionality from the crosslinker to vinyl functionality.
“Wt % s-MgO (70-130 μm)” refers to wt % of spherical MgO particles with D50 in a range of 70 to 130 μm relative to the total weight of all components in the sample.
“Wt % Al₂O₃ (15-40 μm)” refers to wt % of Al₂O₃ particles with D50 in a range of 15 to 40 μm relative to the total weight of all components in the sample.
“ER” and “TC” were evaluated according to the test methods described above.

Table 3 contains characterization results for CE1 to CE6 samples. CEs 1-6 samples, each of which is free of one or more of the claimed TC fillers (c1) though (c4) (e.g., different from IE samples in types and/or particle size) and/or outside their claimed concentrations, all failed to achieve one or both of the above TC and ER requirements. CE1 was used to substantially repeat Ex 3 of WO2020261958A1. CE1 sample that contains 47% of MgO and that does not have aluminum oxide filler with a D50 in a range of 15 to 40 μm and a zinc oxide filler with a D50 of 0.1 to 1 μm failed to achieve both the ER and TC requirements even when the samples include just aluminum oxide filler that is smaller than 15 μm. CE2 samples using spherical MgO with a D50 of 50 μm gave a powdery paste and TC cannot be measured. Sample that does not comprise Al₂O₃ with a D50 of 15 to 40 μm but just Al₂O₃ filler that is smaller than 15 μm (CE3) or higher than 40 μm (CE4) failed to provide one of the TC and ER requirements. CE5 sample that does not have ZnO with a D50 of 0.1 to 1 μm failed to achieve both of TC and ER requirements. CE6 was used to substantially repeat Ex 5 of WO2022075434A1. CE6 sample that does not have Al₂O₃ with a D50 of 15 to 40 μm and ZnO with a D50 of 0.1 to 1 μm achieved undesirably low ER.

TABLE 3

| Component | CE1 | CE2 | CE3 | CE4 | CE5 | CE6 |
|---|---|---|---|---|---|---|
| Vinyl Polymer A-1 | 2.793 | 1.893 | 1.893 | 1.893 | 1.963 | 2.868 |
| SiH Crosslinker B-1 | 0.690 | 0.490 | 0.490 | 0.490 | 0.469 | 0.663 |
| SiH Crosslinker B-2 | 0.150 | 0.150 | 0.150 | 0.150 | 0.192 | 0.144 |
| Treating Agent D-1 | 0.150 | 0.150 | 0.150 | 0.150 | 0.144 | 0.144 |
| Treating Agent D-2 | 1.700 | 1.700 | 1.700 | 1.700 | 1.628 | 1.635 |
| TC Filler C1-1 | 47.20 | | 36.00 | 36.00 | 36.11 | 34.81 |
| TC Filler C1-3 | | 36.00 | | | | |
| TC Filler C2-2 | | 21.00 | | | 21.07 | |
| TC Filler C2-4 | | | | 21.00 | | |
| TC Filler C2-5 | 23.60 | | 21.00 | | | |
| TC Filler C2-6 | | | | | | 25.10 |
| TC Filler C3-1 | | 24.90 | 24.90 | 24.90 | 24.71 | 20.00 |
| TC Filler C3-2 | 23.60 | | | | | |
| TC Filler C4-1 | | 13.60 | 13.60 | 13.60 | | |
| TC Filler C4-2 | | | | | 13.6 | 14.52 |
| Catalyst E-1 | 0.060 | 0.060 | 0.060 | 0.060 | 0.057 | 0.060 |
| Inhibitor F-1 | 0.008 | 0.008 | 0.008 | 0.008 | 0.008 | 0.008 |
| Pigment G-1 | 0.050 | 0.050 | 0.050 | 0.050 | 0.048 | 0.048 |
| Characterization | | | | | | |
| SiH/Vi ratio | 0.824 | 0.894 | 0.894 | 0.894 | 0.880 | 0.771 |
| Wt % filler | 94.4 | 95.5 | 95.5 | 95.5 | 95.5 | 94.4 |
| Vol % filler | 81.3 | 83.8 | 83.8 | 83.8 | 84.4 | 82.0 |
| Wt % s-MgO (70-130 μm) | 47.2 | 0.0 | 36.0 | 36.0 | 36.1 | 34.8 |
| Wt % Al₂O₃ (15-40 μm) | 0 | 21.0 | 0.0 | 0.0 | 21.1 | 0 |
| ER (g/min) | 13 | 0 | 91 | 42 | 56 | 13 |
| TC (W/m*K) | 7.551 | NA | 7.683 | 9.433 | 7.996 | 8.968 |

1. A curable thermally conductive composition comprising:
(A) from 1.0 to 4.0 weight-percent of an alkenyl-functional polyorganosiloxane having a viscosity in a range of 25 to 500 millipascal*seconds as determined by ASTM D445-21 using a glass capillary Cannon-Fenske type viscometer at 25 degrees Celsius, wherein the alkenyl-functional polyorganosiloxane has an average chemical structure (I):
R^{a}_{(3-c)}R′_{c}SiO—(R′R^{a}SiO)ₐ—(R^{a}₂SiO)_{b}—SiR′_{d}R^{a}_{(3-d)} (I)
where R^{a} is independently in each occurrence a monovalent hydrocarbon group free of aliphatic unsaturation, R′ is independently in each occurrence an alkenyl group, subscript a≥0, subscript b>0, subscript c is 0 or 1, subscript d is 0 or 1, (a+b) is 20 to 200, and (a+c+d)≥2;
(B) a silyl-hydride functional polysiloxane crosslinker that contains at least two silyl-hydride groups per molecule and that is present at a concentration to provide a molar ratio of silicon-bonded hydrogen atoms to alkenyl groups for the composition of 0.4 to 1.5;
(C) from 92 to 96 weight-percent of thermally conductive fillers comprising:
(c1) from 15 to 40 weight-percent of spherical magnesium oxide particles having a D50 in a range of 70 to 130 micrometers,
(c2) from 15 to 45 weight-percent of aluminum oxide particles having a D50 in a range of 15 to 40 micrometers,
(c3) from 20 to 32 weight-percent of spherical aluminum oxide particles having a D50 in a range of 1 to 5 micrometers, and
(c4) from 8 to 20 weight-percent of zinc oxide particles having a D50 in a range of 0.1 to less than 1 micrometer; and
(D) a filler treating agent selected from a trialkoxysilyl diorganopolysiloxane, an alkyl trialkoxysilane, or mixtures thereof;
where weight-percentages are relative to curable thermally conductive composition weight.

2. The curable thermally conductive composition of claim 1, further comprising:
(E) a platinum-based hydrosilylation reaction catalyst in an amount sufficient to provide 0.5 to 300 ppm of the platinum, by weight based on the weight of the curable thermally conductive composition.

3. The curable thermally conductive composition of claim 1, further comprising:
(F) a hydrosilylation reaction inhibitor at a concentration of 0.001 to 0.3 weight-percent, based on the weight of the curable thermally conductive composition.

4. The curable thermally conductive composition of claim 1, wherein the alkenyl-functional polyorganosiloxane comprises a vinyldimethylsiloxy-terminated polydimethylpolysiloxane having an average chemical structure (II):
Vi(CH₃)₂SiO—((CH₃)₂SiO)_{b}—Si(CH₃)₂Vi (II)
where Vi represents vinyl and subscript b has a value of 20 to 200.

5. The curable thermally conductive composition of claim 1, wherein the filler treating agent comprises, based on the weight of the curable thermally conductive composition, 0.5 to 2.5 weight-percent of a mono-trialkoxysiloxy terminated diorganopolysiloxane having the average chemical structure (IV):
R^{c}₃Si[OR^{d}₂Si]_{g}—Y—Si(OR^{e})₃ (IV)
where R^{c}, R^{d}, and R^{e} are independently in each occurrence selected from hydrocarbon groups having from 1 to 10 carbon atoms; subscript g has a value of 25 to 110; and Y is O or a (CH₂)ₙ linkage group, where subscript n has a value of 0 to 6.

6. The curable thermally conductive composition of claim 1, wherein (c2) the aluminum oxide particles comprise spherical, roundish, or polyhedron particles, or combinations thereof.

7. The curable thermally conductive composition of claim 1, wherein (c1) the spherical magnesium oxide particles have a D50 in a range of 90 to 120 micrometers.

8. The curable thermally conductive composition of claim 1, wherein (C) the thermally conductive fillers comprise:
(c1) from 25 to 38 weight-percent of spherical magnesium oxide particles having a D50 of 90 to 120 micrometers,
(c2) from 15 to 25 weight-percent of spherical, roundish, or polyhedron aluminum oxide particles having a D50 of 20 to 40 micrometers,
(c3) from 20 to 30 weight-percent of spherical aluminum oxide particles having a D50 of 1 to 5 micrometers, and
(c4) from 10 to 18 weight-percent of irregular zinc oxide particles having a D50 of 0.1 to 0.5 micrometer.

9. The curable thermally conductive composition of claim 1, having an extrusion rate of 60 grams per minute or more and, upon curing, having a thermal conductivity of at least 8.5 Watts per meter*Kelvin using a hot disk according to ISO 22007-2.

10. A process for using the curable thermally conductive composition of claim 1, comprising:
(i) providing the curable thermally conductive composition,
(ii) applying the curable thermally conductive composition on an electronic component, and
(iii) curing the curable thermally conductive composition by heat.

11. An electronic article comprising the curable thermally conductive composition of claim 1 and an electronic component where the thermally conductive composition is applied on, wherein the curable thermally conductive composition is in a cured form.
